(19) United States
(12) Patent Application Publication
(10) Pub. No.: US 2015/0134396 A1
(43) Pub. Date: May 14, 2015

(54) CLOUD-COMPUTING INFRASTRUCTURE

(71) Applicant: Xerox Corporation, Norwalk, CT (US)

(72) Inventors: Tridib Mukherjee, Bangalore (IN); Sujit Gujar, Bangalore (IN)

(73) Assignee: Xerox Corporation, Norwalk, CT (US)

(21) Appl. No.: 14/077,584

(22) Filed: Nov. 12, 2013

(51) Int. Cl. G06Q 10/06

(52) U.S. Cl. CPC G06Q 10/06315
USPC 705/7.25

(57) ABSTRACT

Disclosed embodiment illustrated herein methods and systems for allocating one or more tasks to at least one computing device. The method includes, in a marketplace server, receiving a beacon message from the at least one computing device. The beacon message comprises information on availability of one or more computational resources associated with the at least one computing device. A service level agreement is defined for each of the one or more tasks based on the availability of the one or more computational resources. The one or more tasks are allocated to the at least one computing device based on the service level agreement and the availability of the one or more computational resources.

### TECHNICAL FIELD

The presently disclosed embodiments are related, in general, to cloud-computing infrastructure. More particularly, the presently disclosed embodiments are related to methods and systems for managing one or more tasks in a cloud-computing infrastructure.

### BACKGROUND

Advancements in the field of virtualization and shared computing have led to the development of cloud-computing infrastructure. The cloud-computing infrastructure may include a data center that has one or more computational resources. These computational resources may be allocated to a requestor for performing one or more operations. Examples of the computational resources may include, but are not limited to, one or more processor instances, storage space, and RAM memory space.

Volunteer computing is a type of cloud-computing infrastructure in which maintaining the data center having the one or more computational resources may not be required. Such cloud-computing infrastructure includes a marketplace server and one or more volunteer computing devices. The one or more volunteer computing devices share one or more respective computational resources with the marketplace server. The marketplace server utilizes the shared one or more computational resources to execute applications/projects by transmitting the applications/projects to the corresponding volunteer computing devices for execution. In an embodiment, a volunteer user of the volunteer computing device may select the applications/projects that may use the shared one or more computational resources during a period where the one or more computational resources are idle. The execution of the selected application/project may be halted when the shared one or more computational resources are needed to execute some other application on the respective volunteer computing device. Hence, maintaining service level agreements (SLAs) for execution of the projects/applications in volunteer computing based cloud-computing infrastructures is difficult.

### SUMMARY

According to embodiments illustrated herein there is provided a method for processing one or more tasks on a computing device. The method includes communicating availability of one or more computational resources associated with the computing device to a marketplace server through a beacon message. The one or more tasks from the marketplace server are received based on the availability of the one or more computational resources and a service level agreement associated with the one or more tasks. Further, the one or more tasks are executed by utilizing the one or more available computational resources to generate a result. A payment from the marketplace server is received based on the utilization of the one or more available computational resources for executing the one or more tasks.

According to embodiments illustrated herein there is provided a method for allocating one or more tasks to at least one computing device. The method includes, in a marketplace server, receiving a beacon message from the at least one computing device. The beacon message comprises information on availability of one or more computational resources associated with the at least one computing device. A service level agreement is defined for each of the one or more tasks based on the availability of the one or more computational resources. The one or more tasks are allocated to the at least one computing device based on the service level agreement and the availability of the one or more computational resources.

According to embodiments illustrated herein there is provided a computing device for processing one or more tasks. The computing device includes one or more processors operable to communicate availability of one or more computational resources associated with the computing device to a marketplace server through a beacon message. Further, the one or more processors are operable to receive the one or more tasks from the marketplace server based on the availability of the one or more computational resources and a service level agreement associated with the one or more tasks. The one or more processors are further operable to execute the one or more tasks by utilizing the one or more available computational resources to generate a result. The result is communicated to the marketplace server.

According to embodiments illustrated herein there is provided a marketplace server for allocating one or more tasks to at least one computing device. The marketplace server includes one or more processors operable to receive a beacon message from the at least one computing device. The beacon message comprises information on availability of one or more computational resources associated with each of the at least one computing device. The one or more processors are further operable to define a service level agreement for each of the one or more tasks based on the availability of the one or more computational resources. Further, the one or more processors are further operable to allocate the one or more tasks to the at least one computing device based on the service level agreement and the availability of the one or more computational resources.

According to embodiments illustrated herein there is provided a computer program product for use with a computing device. The computer program product comprising a non-transitory computer-readable medium having a computer readable program code embodied therein for processing one or more tasks on the computing device. The computer readable program code executable by a processor in the computing device for communicating availability of one or more computational resources associated with the computing device to a marketplace server through a beacon message. The one or more tasks are received from the marketplace server based on the availability of the one or more computational resources and a service level agreement associated with the one or more tasks. The one or more tasks are executed by utilizing the one or more available computational resources to generate a result. A payment is received from the marketplace server based on the utilization of the one or more available computational resources for executing the one or more tasks.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit, the scope in any manner, wherein like designations denote similar elements, and in which:

FIG. 1 is a block diagram illustrating a system environment in which various embodiments can be implemented;

FIG. 2 is a message flow diagram illustrating flow of messages/data for registering a volunteer computing device with a marketplace server, in accordance with at least one embodiment;

FIG. 3 is a message flow diagram illustrating a flow of messages/data for allocating one or more tasks, in accordance with at least one embodiment;

FIG. 4 is a block diagram of a marketplace server, in accordance with at least one embodiment;

FIG. 5 is a flowchart illustrating a method for allocating one or more tasks to one or more computing devices, in accordance with at least one embodiment;

FIG. 6 is a block diagram illustrating a volunteer computing device, in accordance with at least one embodiment; and

FIG. 7 is a flowchart illustrating a method performable by a volunteer computing device to process one or more tasks, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “at least one embodiment”, “an embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

“Computational resources” correspond to resources utilized for executing a project/application. In an embodiment, the computational resources correspond to, but are not limited to, processor instances, storage space, and RAM space. In an embodiment, the computational resources may further correspond to, but not limited to, software applications, security services, and database services that can be utilized by the computing device.

A “cloud-computing infrastructure” corresponds to a universal collection of computational resources over the internet (such as computing instances, storage, information hardware, various platforms, and services) and forms individual units within the virtualization environment. In an embodiment, one or more computing devices, registered with the cloud-computing infrastructure, utilize the resources to perform respective operations. In an embodiment, cloud-computing infrastructure may provide one or more services such as, but not limited to, Infrastructure as a service (IaaS), Platform as a service (Paas), Software as a service (SaaS), Storage as a service (STaaS), Security as a service (SECaaS), and Data as a service (DaaS).

A “Marketplace” refers to a type of e-commerce website where product and inventory information is provided by multiple third parties. Transactions are processed by the marketplace owner. In an embodiment, the online marketplace publishes the availability of the computational resources. Some examples of online marketplace include, but are not limited to, E-bay.com, Amazon.com, Flipkart.com, Amazon web services (AWS), Windows Azure, and the like.

A “Service level agreement” refers to an agreement between a requestor and a marketplace that defines various benchmarks that marketplace may have to achieve during execution of the projects/applications. In an embodiment, the one or more parameters include, but are not limited to, mean time between failures (MTBF), mean time to recovery (MTTR), throughput, etc. The marketplace may have to fulfill the requirements (i.e., benchmarks) to receive payment from the requestor.

“Mean time between failures” refers to a number of failures per million hours of usage of one or more computational resources.

A “task” refers to a piece of work, a processor thread, or a set of instructions to be performed. Tasks may necessitate the involvement of one or more computational resources.

“Payment” refers to a remuneration received by an owner of a computing device for sharing one or more computational resources. The one or more computational resources are utilized for execution of projects/applications. The payment is received based on usage of the one or more computational resources. In an embodiment, the payment is a monetary compensation received by the owner of the computing device. However, a person having ordinary skills in the art would understand that the scope of the disclosure is not limited to remunerating monetary compensation to the owner. In an embodiment, various other means of remunerating the owner may be employed such as, remunerating crowdworkers with lottery tickets, giving gift items, shopping vouchers, and discount coupons. In another embodiment, payment may further correspond to strengthening of the relationship between owner of the computing device and marketplace server. For example, the marketplace server may provide access to more projects so that the owner has more gain. In addition, the marketplace server may improve the reputation score of the computing device so that more projects are directed to the computing device for execution. A person skilled in the art would understand that combination of any of the above mentioned means of remuneration could be used for paying the owner of the computing device.

A “reputation score” refers to a score allocated by a marketplace server to the one or more computational resources. The reputation score is indicative of reliability of the one or more computational score for execution of the projects/applications.

“Quality associated with one or more computational resources” refers to at least one of a computing power of the one or more computational resources, or a measure of mean time to failure associated with the one or more computational resources.

A “beacon message” refers to a periodic message transmitted by a computing device to the marketplace indicating availability of the computational resources associated with the computing device. For example, if none of the computational resources are available, the computing device will transmit a beacon message indicating that none of the computational resources are available.

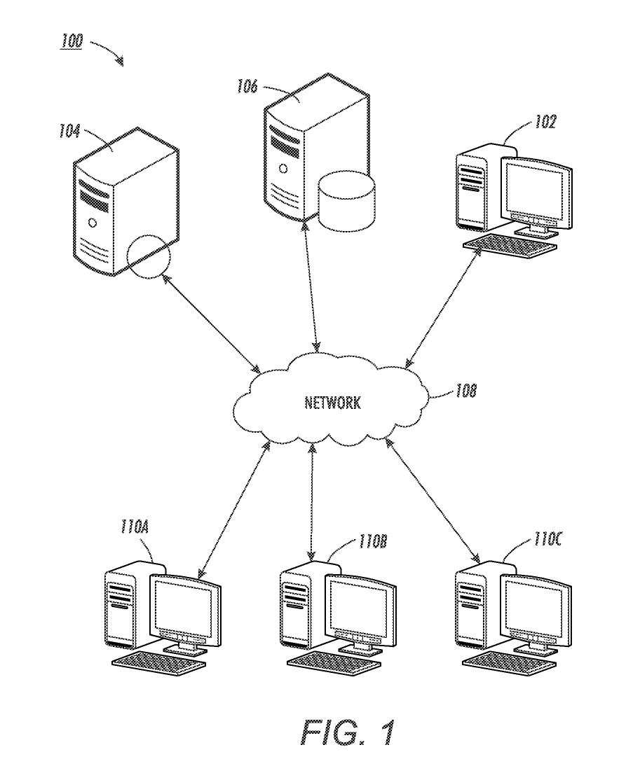

FIG. 1 is a block diagram of a system environment 100 in which various embodiments can be implemented. The system environment 100 includes a requestor-computing device 102, a marketplace server 104, a database server 106, a network 108, and one or more volunteer computing devices 110a, 110b, and 110c (hereinafter referred as volunteer computing devices 110).

The requestor-computing device 102 executes one or more projects/applications to perform a predetermined operation. In an embodiment, the requestor-computing device 102 may not have enough computational power to execute some of the process threads. The requestor-computing device 102 may transmit such process threads to the marketplace server 104 as one or more tasks. Additionally, the requestor-computing device 102 transmits metadata associated with the one or more tasks to the marketplace server 104. In an embodiment, the metadata may include data to be processed, and computational resource requirements for executing the one or more process threads. In an embodiment, the requestor-computing device 102 may transmit complete process/application to the marketplace server 104 for execution. The requestor-computing device 102 may receive an SLA pertaining to execution of the one or more tasks from the marketplace server 104. Examples of the requestor-computing device 102 include, but are not limited to, a personal computer, a laptop, a personal digital assistant (PDA), a mobile device, a tablet, or any other computing device that has capability to transmit one or more process threads to the marketplace server 104.

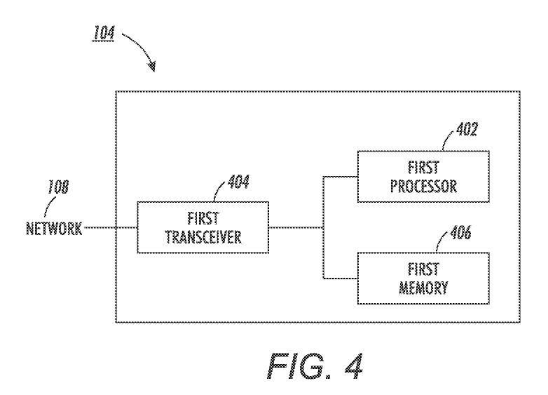

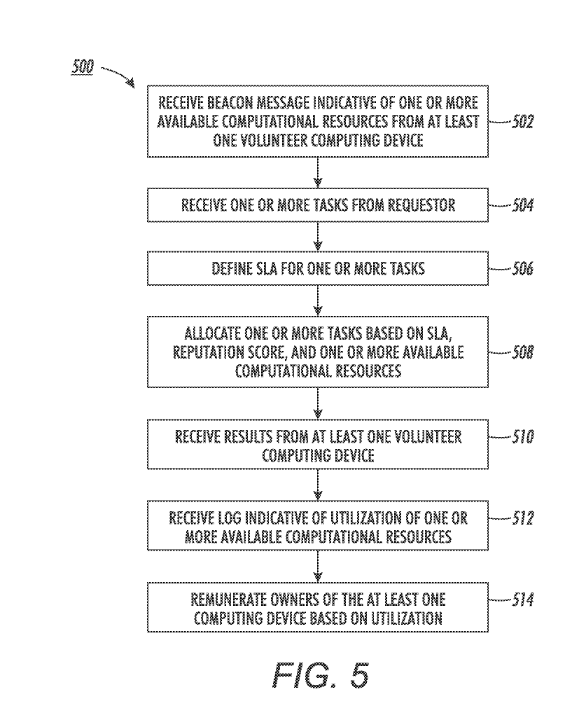

The marketplace server 104 receives a beacon message from one or more of the volunteer computing devices 110 indicating availability of the one or more computational resources. The marketplace server 104 stores the information on the availability of the one or more computational resources in the database server 106. Additionally, the marketplace server 104 receives the one or more tasks and respective metadata from the requestor-computing device 102. Based on the availability of the one or more computational resources and the computational resource requirements for executing the one or more process threads in the one or more tasks, the marketplace server 104 allocates the one or more tasks to at least one volunteer computing device 110 (for example, the volunteer computing device 110a). The marketplace server 104 is described later in conjunction with FIG. 4 and FIG. 5. The marketplace server 104 can be implemented as an application server. Some examples of know application server includes, but are not limited to, Java application server, .NET framework, and Base4 application server.

The database server 106 stores information associated with the availability of the one or more computational resources. Further, the database server 106 stores the metadata associated with the one or more tasks received by the marketplace server 104. In an embodiment, the database server 106 may receive a query from the marketplace server 104 to extract the availability of the one or more computational resources and the metadata associated with the one or more tasks. The database server 106 may be realized through various technologies such as, but not limited to, Microsoft® SQL server, Oracle, and My SQL. In an embodiment, the marketplace server 104 may connect to the database server 106 by using one or more protocols such as, but not limited to, ODBC protocol and JDBC protocol.

A person having ordinary skills would understand that the scope of the disclosure should not be limited to the database server 106 as a separate entity. In an embodiment, the database server 106 may be contained in the marketplace server 104.

The network 108 corresponds to a medium through which content and messages/signal flow between various devices of the system environment 100 (e.g., the requestor-computing device 102, the marketplace server 104, the database server 106, and the volunteer computing devices 110). Examples of the network 108 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 108 in accordance with various wired and wireless communication protocols such as Transmission Control Protocol and Internet Protocol (TCP/IP), User Datagram Protocol (UDP), and 2G, 3G, or 4G communication protocols.

The volunteer computing devices 110 transmits the beacon message to the marketplace server 104 indicative of availability of the one or more computational resources. The volunteer computing devices 110 may receive at least one task from the marketplace server 104 based on the availability. The volunteer computing devices 110 process the at least one task to generate a result. Further, the volunteer computing devices 110 transmit the result to the marketplace server 104. Examples of the volunteer computing devices 110 include, but are not limited to, a personal computer, a laptop, a personal digital assistant (PDA), a mobile device, a tablet, or any other computing device.

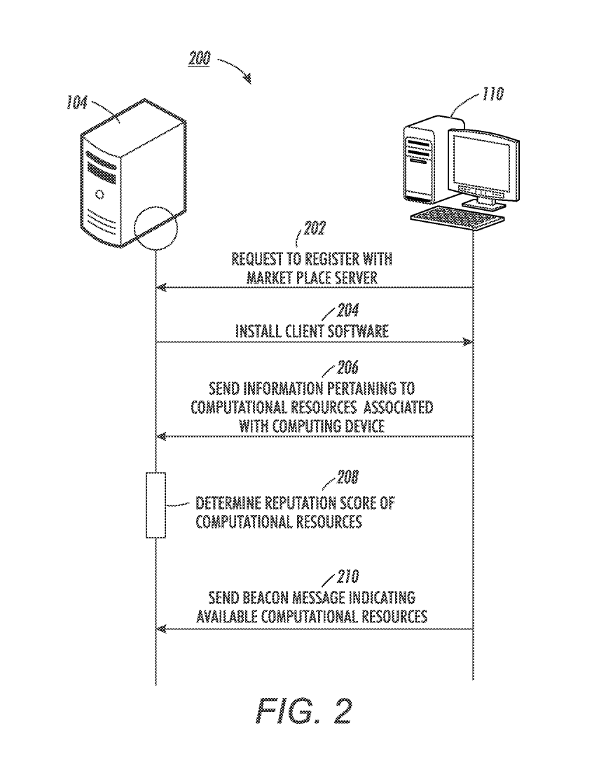

FIG. 2 is a message flow diagram 200 illustrating flow of messages/data for registering the volunteer computing device 110a with the marketplace server 104, in accordance with at least one embodiment. The message flow diagram 200 is described in conjunction with FIG. 1.

The volunteer computing device 110a transmits a request to the marketplace server 104 for registration (depicted by 202). On receiving the request, the marketplace server 104 may transmit a registration form to the volunteer computing device 110a. An owner of the volunteer computing device 110a may provide one or more inputs to the volunteer computing device 110a to fill up the form. In an embodiment, the form may include one or more fields for disclosing information pertaining to the one or more computational resources associated with the volunteer computing device 110a. In an embodiment, the one or more computational resources may include a number and a type of CPU core in the volunteer computing device 110a, disk and memory space available in the volunteer computing device 110a, platform (e.g., Windows®, Linux, and Macintosh®) or the operating system installed on the volunteer computing device 110a. The volunteer computing device 110a transmits the filled registration form to the marketplace server 104.

On receiving the filled registration form, the marketplace server 104 sends a client software to the volunteer computing device 110a for installation (depicted by 204). In an embodiment, the marketplace server 104 determines the operating system/platform on the volunteer computing device 110a from the filled registration form. Accordingly, the marketplace server 104 sends an appropriate version of the client software to the volunteer computing device 110a for installation. For example, if the marketplace server 104 determines that the operating system on the volunteer computing device 110a is Linux, the marketplace server 104 may send the client software in “.rpm” or “.deb” file format for installation. In an embodiment, the client software includes a benchmark tool that is operable to execute one or more scripts on the volunteer computing device 110a to determine the information pertaining to the one or more computational resources. Further, the client software on the volunteer computing device 110a transmits the information pertaining to the one or more computational resources to the marketplace server 104 (depicted by 206).

The marketplace server 104 compares the information received from the client software with the information obtained from the registration form to compute a reputation score for the one or more computational resources (depicted by 208). In an embodiment, the marketplace server 104 assigns a high reputation score to the one or more computational resources if the information received from the client software matches with the information obtained from the registration form. If the information received from the client software does not match with the information obtained from the registration form, the marketplace server 104 assigns a low reputation score. Further, marketplace server 104 assigns the reputation score based on quantity and quality of the one or more computational resources. For example, the one or more computational resources for the volunteer computing device 110a include a dual-core processor, 2 GB RAM, and 500 GB hard disk. The one or more computational resources for the volunteer computing device 110b include a Quad-core processor, 4 GB RAM, 1 TB Hard disk, and 1 GPU (Graphics Processing Unit). The marketplace server 104 assigns high reputation score to the computational resources associated with the volunteer computing device 110b in comparison to the computational resources associated with the volunteer computing device 110a.

A person skilled in the art would understand that scope of the disclosure is not limited to assigning the reputation score based on the quantity and quality of the one or more computational resources. In an embodiment, the marketplace server 104 may assign the reputation score based on the time for which the one or more computational resources are available, mean time to failure associated with the one or more computational resources, and mean time to repair the one or more computational resources.

The client software on the volunteer computing device 110a transmits a beacon message to the marketplace server 104 indicating availability of the one or more computational resources (depicted by 210). In an embodiment, the client software transmits the beacon message periodically.

A person having ordinary skills in the art would understand that scope of the disclosure is not limited to communicating with a single volunteer computing device 110a. In an embodiment, the marketplace server may communicate with other volunteer computing devices such as volunteer computing device 110b and the volunteer computing device 110c. For the sake of simplicity, the forgoing description has been described using one volunteer computing device 110a.

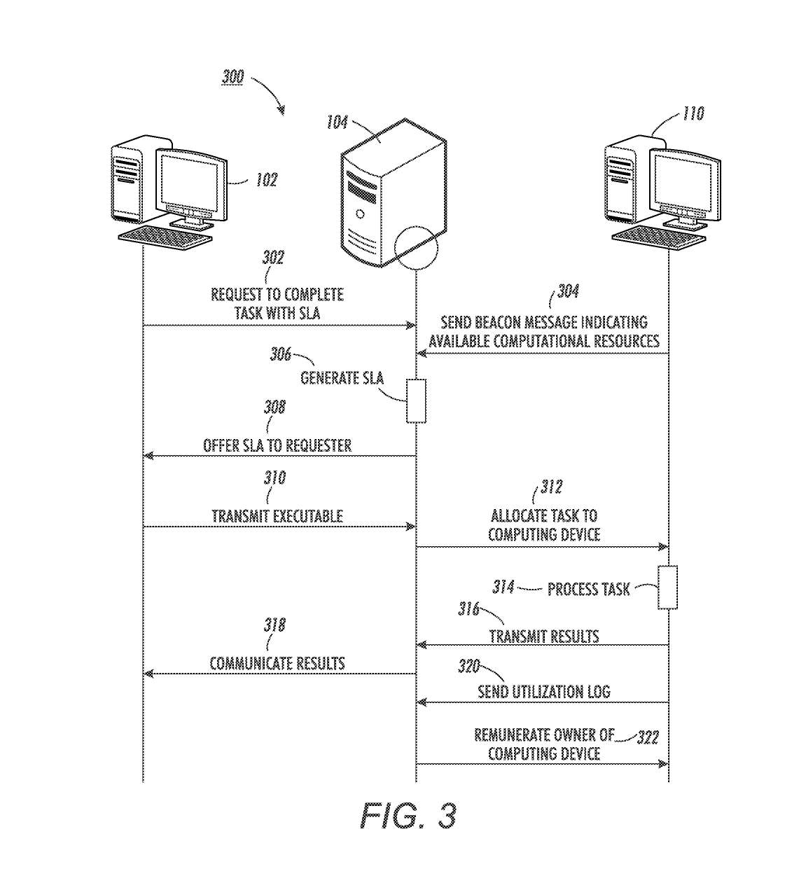

FIG. 3 is a message flow diagram 300 illustrating a flow of messages/data for allocating one or more tasks, in accordance with at least one embodiment. The message flow diagram 300 is described in conjunction with FIG. 1.

The requestor-computing device 102 transmits a request to complete a task to the marketplace server 104 (depicted by 302). The marketplace server 104 receives a beacon message from the requestor-computing device 102 indicating availability of the one or more computational resources associated with the volunteer computing device 102 (depicted by 304).

The marketplace server 104 generates an SLA for the task request received by the marketplace server 104 based on the available one or more computational resources (depicted by 306). The generation of the SLA is described later in conjunction with FIG. 5. The marketplace server 104 offers the generated SLA to the requestor-computing device 102 (depicted by 308). The owner of the requestor-computing device 102 may accept or reject the SLA. In case the owner of the requestor-computing device 102 accepts the SLA, the requestor-computing device 102 transmits the task and associated metadata to the marketplace server 104 (depicted 310).

The marketplace server 104 analyzes the metadata associated with the task to determine the one or more computational resources that may be required to complete the task. Thereafter, the marketplace server 104 determines availability of the one or more computational resources. Based on the availability, the marketplace server 104 allocates the task to at least one volunteer computing device 110a (depicted by 312). The allocation of the task is described later in conjunction with FIG. 5.

The volunteer computing device 110a processes the task using the one or more computational resources to generate a result (depicted by 314). Further, the volunteer computing device 110a transmits the result to the marketplace server 104 (depicted by 316). The marketplace server 104 forwards the result to the requestor-computing device 102 (depicted by 318).

The client software, installed on the volunteer computing device 110a, transmits a utilization log, indicative of utilization of the one or more computational resources, to the marketplace server 104 (depicted by 320). In an embodiment, the utilization log is indicative of usage of the one or more computational resources in processing the task. The marketplace server 104 remunerates the owner of the volunteer computing device 110a based on the utilization log (depicted by 322).

FIG. 4 is a block diagram of the marketplace server 104, in accordance with at least one embodiment. The marketplace server 104 includes a first processor 402, a first transceiver 404, and a first memory 406. The first processor 402 is coupled to the first transceiver 404 and the first memory 406. The first transceiver 404 is connected to the network 108.

The first processor 402 includes suitable logic, circuitry, and/or interfaces is operable to execute one or more instructions stored in the first memory 406 to perform predetermined operation on the marketplace server 104. The first memory 406 may be operable to store the one or more instructions. The first processor 402 may be implemented using one or more processor technologies known in the art. Examples of the first processor 402 include, but not limited to, an X86 processor, a RISC processor, an ASIC processor, a CISC processor, or any other processor.

The first transceiver 404 transmits and receives messages and data to/from various components of the system environment 100 (e.g., the requestor-computing device 102, the database server 106, and the volunteer computing devices 110). Examples of the first transceiver 404 may include, but are not limited to, an antenna, an Ethernet port, a USB port or any other port that can be configured to receive and transmit data. The first transceiver 404 transmits and receives data/messages in accordance with the various communication protocols, such as, TCP/IP, UDP, and 2G, 3G, or 4G communication protocols.

The first memory 406 stores a set of instructions and data. Some of the commonly known memory implementations include, but are not limited to, a random access memory (RAM), a read only memory (ROM), a hard disk drive (HDD), and a secure digital (SD) card. Further, the first memory 406 includes the one or more instructions that are executable by the first processor 402 to perform specific operations. It is apparent to a person having ordinary skills in the art that the one or more instructions stored in the first memory 406 enable the hardware of the marketplace server 104 to perform the predetermined operation.

FIG. 5 is a flowchart 500 illustrating a method for allocating one or more tasks to one or more computing devices, in accordance with at least one embodiment. The flowchart 500 is described in conjunction with FIG. 1 and FIG. 4.

At step 502, a beacon message indicative of availability of the one or more computational resources is received from one or more of the volunteer computing devices 110. In an embodiment, the first processor 402 receives the beacon message through the first transceiver 404. Prior to receiving the beacon message, the first processor 402 receives a request for registration from the volunteer computing devices 110. On receiving the request for registration, the first processor 402 transmits a registration form through the first transceiver 404. In an embodiment, the owner of each of the one or more volunteer computing devices 110 fills the registration forms to provide first information pertaining to the one or more computational resources associated with the volunteer computing devices 110. The first processor 402 receives the registration forms from the volunteer computing devices 110 through the first transceiver 404. Further, the first processor 402 stores the first information in the first memory 406.

Thereafter, the first processor 402 transmits client software to the volunteer computing devices 110 through the first transceiver 404 for installation. Post installation of the client software, the first processor 402 receives second information pertaining to the one or more computational resources associated with each of the volunteer computing devices 110. The first processor 402 stores the second information in the first memory 406.

The first processor 402 is operable to assign a reputation score to the one or more computational resources of each of the volunteer computing devices 110 based the first information (obtained from registration forms) and the second information (obtained from client software). In an embodiment, the first processor 402 assigns a high reputation score to the one or more computational resources associated with a volunteer computing device 110a if the first information and the second information are in accord. Similarly, the first processor 402 assigns a low reputation score to the one or more computational resources associated with a volunteer computing device 110a if the first information and the second information are not in accord. Following table illustrates an example representation of the first information, the second information, and the corresponding reputation score:

TABLE 1
Example representation of the first information and the second information

| Volunteer | First information pertaining | Second information | Reputation |
|---|---|---|---|
| computing | to the one or more | pertaining to the one or more | Score (scale |
| devices | computational resources | computational resources | of 1-10) |
| Volunteer | 2.2 Ghz dual-core processor | 2.2 Ghz Single-core processor | 4 |
| computing | 2 GB RAM | 1 GB RAM | |
| device 110a | 250 GB Hard disk | 160 GB Hard disk | |
| Volunteer | 3 Ghz single-core processor | 3 Ghz single-core processor | 8 |
| computing | 1 GB RAM | 1 GB RAM | |
| device 110b | 160 GB Hard disk | 160 GB Hard disk | |
| Volunteer | 2.4 Ghz Quad-core processor | 2.4 Ghz Quad-core processor | 7 |
| computing | GPU | 4 GB RAM | |
| device 110c | | 250 GB Hard disk | |

The first processor 402 stores the reputation score obtained based on the comparison between the first information and the second information in the first memory 406. In an embodiment, the first processor 402 assigns the reputation score based on the quantity and quality of the one or more computational resources, a mean time to failure (MTTF) associated with the one or more computational resources, and time for which the one or more computational resources are available. In an embodiment, the first processor 402 may determine a cumulative reputation score by determining a weighted sum of reputation score determined based on the comparison between the first information and the second information, reputation score determined based on the quantity and quality of the one or more computational resources, MTTF associated with the one or more computational resources, and time for which the one or more computational resources are available.

The first processor 402 receives the beacon message from the volunteer computing devices 110. Further, the first processor 402 is operable to maintain a log of available computational resources. Following table illustrates an example log of available computational resources:

TABLE 2
Example representation of the first information and
the second information

| | | Availability of |
|---|---|---|
| | Beacon message | computational |
| Volunteer computing devices | received? | resources |
| Volunteer computing device 110a | Yes | Available |
| Volunteer computing device 110b | No | Not-Available |
| Volunteer computing device 110c | Yes | Available |

In an embodiment, the first processor 402 may determine availability of the one or more computational resources based on a historical data maintained by the first processor 402 in the first memory 406. In an embodiment, the historical data includes information related to a time period during which the one or more computational resources associated with each of the volunteer computing devices 110 are available. In an embodiment, the first processor 402 may utilize support vector machine (SVM) to maintain historical data pertaining to the one or more computational resources.

At step 504, one or more tasks are received from the requestor-computing device 102. In an embodiment, the first processor 402 receives the one or more tasks from the requestor-computing device 102 through the first transceiver 404. In an embodiment, along with the one or more tasks, the first processor 402 receives metadata associated with the one or more tasks. In an embodiment, the metadata includes data to be processed, type of computational resources required for processing the task, time required to process the task. The first processor 402 is operable to store the one or more tasks and the corresponding metadata in the first memory 406. The following table illustrates a sample representation of the metadata:

TABLE 3
Example representation of metadata associated with
the one or more tasks

| | | Time required for |
|---|---|---|
| Tasks | Task requirements | processing the task |
| Task-1 | Quad-core processor, | 6 Hours |
| | GPU | |
| | 1 GB RAM | |
| Task-2 | Dual-core processor, | 5 Hours |
| | 1 GB RAM | |
| | 1 Gb Hard disk drive | |
| Task-3 | Dual-core processor, | 3 Hours |
| | GPU | |
| | 4 GB RAM | |

At step 506, an SLA is defined for each of the one or more tasks. In an embodiment, the first processor 402 defines the SLA for the one or more tasks based on the metadata associated with the one or more tasks, and the availability of the one or more computational resources. For example, the first processor 402 determines that the “Task-1” requires a “Quad-core processor”, a “GPU”, “1 GB RAM”. Further, the first processor 402 determines that total time that will be required for processing the “Task-1” is 6 hours. Additionally, the first processor 402 determines computational resources that are available and that can meet minimum requirements of the “task-1”. For example, the one or more computational resources associated with the “volunteer computing device 110c” satisfy the minimum requirement for processing the task. In addition, the one or more computational resources associated with the “volunteer computing device 110c” are available. Thus, the first processor 402 will define an SLA declaring that the “task-1” will be processed in 6 hours. In a scenario where the computational resources required by the “task-1” are not available, the first processor 402 may determine when the one or more computational resources will be available. For example, the first processor 402 determines that the computational resources will be available in 4 hours. Then the first processor 402 defines the SLA declaring that the “task-1” will be processed in 10 hours. Post defining of the SLA the first processor 402 transmits the SLA to the requestor-computing device 102 for approval. If the approval on the SLA is received from the requestor-computing device 102, step 508 is performed.

At step 508, each of the one or more tasks is allocated to at least one volunteer computing device 110a. In an embodiment, the first processor 402 allocates the one or more tasks. In an embodiment, the first processor 402 allocates the one or more tasks based on the metadata associated with each of the one or more tasks (illustrated in Table 3) and availability of the one or more computational resources (illustrated in Tables 1 and 2). For example, “Task-2” requires “Dual-core processor”, “1 GB RAM”, and “1 GB hard disk drive” and “Task-3” requires “Dual-core processor”, “GPU”, and “4 GB RAM” for processing. The first processor 402 determines that “volunteer computing device 110c” has a “quad core processor” “4 GB RAM” and a “GPU”, thus the first processor 402 allocates the “Task-3” to the “volunteer computing device 110c” for processing. As none of the volunteer computing devices 110 (depicted in Table 1) has a dual core processor, the “Task-2” may be queued in the pipeline of the “volunteer computing device 110c” because the one or more computational resources associated with the “volunteer computing device 110c” exceed the minimum requirement for processing the “Task-2”. In an embodiment, the first processor 402 utilizes Naïve Bayes method for finding a best match between the minimum requirement for processing the one or more tasks and the available one or more computational resources.

In an alternate embodiment, the first processor 402 allocates the one or more tasks based on the minimum requirements for processing the one or more tasks and a first come first serve algorithms. For example, the “task-2” is received first by the first processor 402 prior to receiving the “task-3”, the first processor 402 allocates the “task-2” to the “volunteer computing device 110c” first and the “task-3” will be queued for processing in pipeline of the “volunteer computing device 110c”.

In another alternate embodiment, the first processor 402 allocates the one or more tasks based on the reputation score associated with the one or more computational resources. For example, the “Task-3” requires a Dual core processor for processing. The first processor 402 determines that the “volunteer computing device 110a” and the “volunteer computing device 110c” have “dual core processor” and “quad core processor”, respectively. Further, the first processor 402 determines that the reputation score of the “volunteer computing device 110a” is less than the reputation score of the “volunteer computing device 110c”, therefore the first processor 402 allocates the “Task-3” to the “volunteer computing device 110c”.

The first processor 402 is operable to allocate the one or more tasks based on the SLA associated with each of the one or more tasks. For example, the SLA for the “Task-1” states that the results will be delivered within 6 hours. Additionally, the SLA states that the reputation score of the one or more computational resources should not be less than “6”. In such a scenario, the first processor 402 determines that the reputation score of the “volunteer computing device 110b” and the “volunteer computing device 110c” is greater than “6”. Further, the first processor 402 determines that the mean time to failure for the “volunteer computing device 110c” is 5 hours and that of the “volunteer computing device 110b” is 7 hours. Thus, the first processor 402 may allocate the “Task-1” to the “volunteer computing device 110b” as the mean time to failure of the one or more computational resources associated with the “volunteer computing device 110b” is greater than the time for processing the “Task-1” (i.e., 6 hours).

In an embodiment, the first processor 402 allocates each of the one or more tasks to more than one volunteer computing device. For instance, if processing of the one or more tasks on one volunteer computing device (e.g., 110a) fails due to power failure, the second volunteer computing device (e.g., 110b) is able to deliver the results so that the SLA associated with each of the one or more tasks is not violated.

At step 510, the results of each of the one or more tasks are received. In an embodiment, the first processor 402 receives the results through the first transceiver 404. The first processor 402 is operable to transmit the results of the one or more tasks to the requestor-computing device 102.

At step 512, a utilization log of the one or more computational resources is received from each of the volunteer computing devices 110. In an embodiment, the first processor 402 receives the utilization log through the first transceiver 404.

At step 514, based on the utilization log, the one or more volunteer computing devices 110 are remunerated. In an embodiment, an owner of the marketplace server 104 releases the remuneration to the owner of the one or more volunteer computing device 110a based on the utilization log. In an embodiment, the pricing of the usage is determined based on the reputation score associated with the one or more computational resources. For example, a first set of computational resources have a reputation score of “8” and a second set of reputation score of the second set of computational resources is “6”. Then pricing for the usage of the first set of computational resource may be higher than the pricing of the usage of the second set of computational resources.

In an alternate embodiment, the remuneration amount associated with the usage of the one or more computational resources varies dynamically and depends on changes in demand-supply of the one or more computational resources. In an embodiment, the first processor 402 enables varying of the remuneration amount associated with the usage of the one or more computational resources by using following rules:
“If demand of the one or more computational resources is less than the availability of the one or more computational resources then price of the usage of the one or more computational resources is reduced.”
“If demand of the one or more computational resources is more than the availability of the one or more computational resources then price of the usage of the one or more computational resources is increased.”

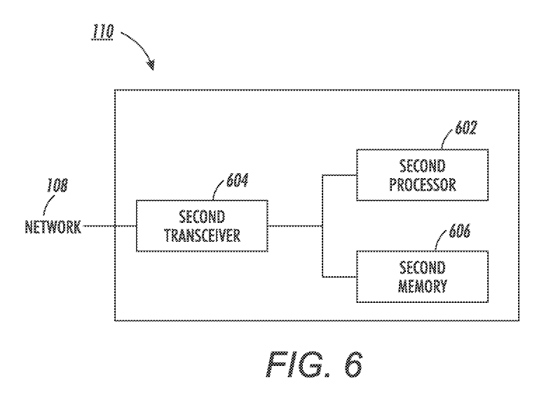

FIG. 6 is a block diagram illustrating the volunteer computing device 110a, in accordance with at least one embodiment. The volunteer computing device 110a includes a second processor 602, a second transceiver 604, and a second memory 606. The second processor 602 is coupled to the second transceiver 604 and the second memory 606. The second transceiver 604 is connected to the network 108.

The second processor 602 includes suitable logic, circuitry, and/or interfaces is operable to execute one or more instructions stored in the second memory 606 to perform predetermined operation on the volunteer computing device 110a. The second memory 606 may be operable to store the one or more instructions. The second processor 602 may be implemented using one or more processor technologies known in the art. Examples of the second processor 602 include, but not limited to, an X86 processor, a RISC processor, an ASIC processor, a CISC processor, or any other processor.

The second transceiver 604 transmits and receives messages and data to/from various components of the system environment 100 (e.g., the requestor-computing device 102, the marketplace server 104, and the database server 106). Examples of the second transceiver 604 may include, but are not limited to, an antenna, an Ethernet port, a USB port or any other port that can be configured to receive and transmit data. The second transceiver 604 transmits and receives data/messages in accordance with the various communication protocols, such as, TCP/IP, UDP, and 2G, 3G, or 4G communication protocols.

The second memory 606 stores a set of instructions and data. Some of the commonly known memory implementations include, but are not limited to, a random access memory (RAM), a read only memory (ROM), a hard disk drive (HDD), and a secure digital (SD) card. Further, the second memory 606 includes the one or more instructions that are executable by the second processor 602 to perform specific operations. It is apparent to a person having ordinary skills in the art that the one or more instructions stored in the second memory 606 enable the hardware of the volunteer computing device 110a to perform the predetermined operation.

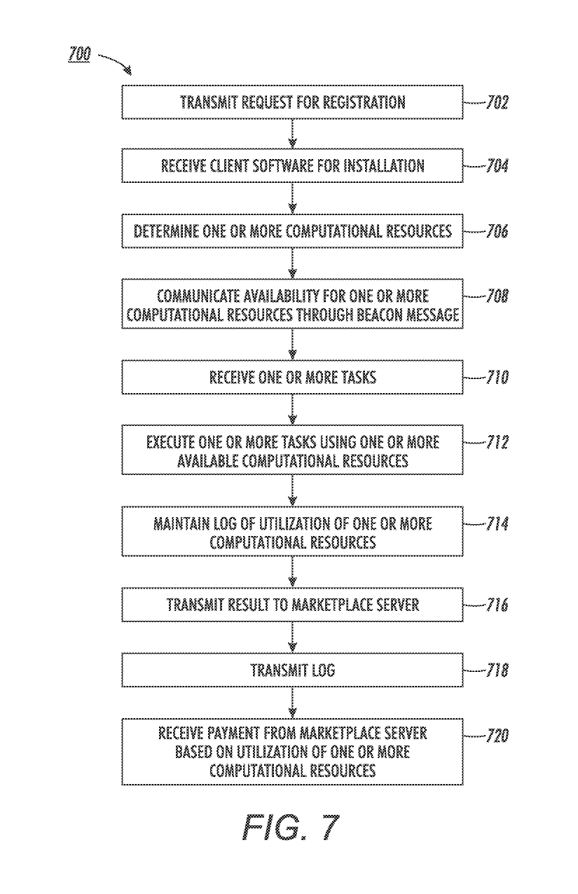

FIG. 7 is a flowchart 700 illustrating a method being performed by the volunteer computing device 110a to process one or more tasks, in accordance with at least one embodiment. The flowchart 700 is described in conjunction with FIG. 6.

At step 702, a request for registration of the volunteer computing device 110a is transmitted to the marketplace server 104. In an embodiment, the second processor 602 transmits the request to the marketplace server 104 through the second transceiver 604. The registration process has been described in step 502.

At step 704, client software is received from the marketplace server 104. In an embodiment, the second processor 602 receives the client software through the second transceiver 604. The second processor 602 is operable to install the client software on the volunteer computing device 110a.

At step 706, the one or more computational resources associated with the volunteer computing device 110a are determined. In an embodiment, the second processor 602 executes one or more scripts in the client software to determine the one or more computational resources. Some examples of the one or more scripts include, but are not limited to, Unixbench, IOzone, LLC, etc. Post determining the one or more computational resources, the information pertaining to the determined one or more computational resources is communicated to the marketplace server 104 by the second processor 602 through the second transceiver 604.

In an alternate embodiment, the client software enables the owner of the volunteer computing device 110a to select a set of computational resources from the one or more computational resources that will be used for executing the one or more tasks received from the marketplace server 104. For example, the volunteer computing device 110a has a quad core processor, 4 GB RAM, and 250 GB hard disk drive. The owner of the volunteer computing device 110a may select that only one core out of four core of processor, 1 GB RAM, 50 GB hard disk will be used for executing the one or more tasks. In such a scenario, the client software may transmit the information that the volunteer computing device 110a has a single core processor, 1 GB RAM, and 50 GB hard disk drive.

At step 708, a beacon message indicative of the availability of the one or more computational resources is transmitted to the marketplace server 104. In an embodiment, the client software instructs the second processor 602 to transmit the beacons signal through the second transceiver 604.

At step 710, one or more tasks are received. In an embodiment, the second processor 602 receives the one or more tasks from the marketplace server 104 through the second transceiver 604. Along with the one or more tasks, the second processor 602 receives metadata associated with the one or more tasks through the second transceiver 604. In an embodiment, the client software scans the one or more tasks and the metadata associated with the one or more tasks for viruses and malwares. If a virus is found, the execution of the one or more tasks is aborted.

At step 712, the one or more tasks are processed using the one or more available computational resources. In an embodiment, the second processor 602 processes the one or more tasks. In an embodiment, the second processor 602 in conjunction with the available second memory 606 are operable to process the one or more tasks.

In an embodiment, the client software on the volunteer computing device 110a presents a user interface (UI) to the owner of the volunteer computing device 110a. The UI enables the owner to monitor the usage of the one or more computational resources.

At step 714, a utilization log of the one or more computational resources is maintained. In an embodiment, the second processor 602 maintains the utilization log.

At step 716, the results obtained by processing the one or more tasks are transmitted to the marketplace server 104. In an embodiment, the second processor 602 transmits the results through the second transceiver 604.

At step 718, the utilization log of the usage of the one or more computational resources is transmitted to the marketplace server 104. In an embodiment, the second processor 602 transmits the utilization log through the second transceiver 604.

Based on the utilization log, the payment for utilization of the one or more computational resources is received by the owner of the volunteer computing device 110.

The disclosed embodiments encompass numerous advantages. One or more volunteer computing devices 110 sends a beacon message to the marketplace server 104 indicating availability of the one or more computational resources. The marketplace server 104 transmits one or more tasks to the one or more volunteer computing devices 110. As the one or more volunteer computing devices 110 are used for processing the one or more tasks, maintaining a data center for processing the one or more tasks is not required. Also, as the owners of the one or more volunteer computing device does not have authority to select the one or more tasks that will be processed on the respective computing devices, the marketplace server manages the processing of the one or more tasks on the volunteer computing devices. Therefore, the marketplace server 104 may schedule the allocation and processing of the one or more tasks in such a manner that the SLA associated with the one or more tasks is not violated. Further, as the tasks are pushed in accordance to the computational requirements of the one or more tasks, SLA violations are minimized.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the cloud-computing infrastructure for tasks have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for processing one or more tasks on a computing device, the method comprising:
communicating availability of one or more computational resources associated with the computing device to a marketplace server through a beacon message;
receiving the one or more tasks from the marketplace server based on the availability of the one or more computational resources and a service level agreement associated with the one or more tasks;
executing the one or more tasks by utilizing the one or more available computational resources to generate a result; and
receiving a payment from the marketplace server based on the utilization of the one or more available computational resources for executing the one or more tasks.

2. The method of claim 1 further comprising determining the one or more computational resources associated with the computing device.

3. The method of claim 1, wherein the one or more computational resources correspond to at least one of a processor, a memory space, or a storage space.

4. The method of claim 1, wherein the availability of the one or more computational resources is periodically communicated to the marketplace server.

5. The method of claim 1 further comprising providing a user interface on the computing device, wherein the user interface enables a user of the computing device to monitor the utilization of the one or more available computational resources.

6. The method of claim 1 further comprising maintaining a log of utilization of the one or more available computational resources to generate the result, wherein the log is transmitted to the marketplace server.

7. The method of claim 1 further comprising communicating the result to the marketplace server.

8. A method for allocating one or more tasks to at least one computing device, the method comprising:
in a marketplace server:
receiving a beacon message from the at least one computing device, wherein the beacon message comprises information on availability of one or more computational resources associated with at least one computing device;
defining a service level agreement for each of the one or more tasks based on the availability of the one or more computational resources; and
allocating the one or more tasks to the at least one computing device based on the service level agreement and the availability of the one or more computational resources.

9. The method of claim 8 further comprising receiving the one or more tasks from one or more requestors.

10. The method of claim 8 further comprising receiving a result for each of the one or more tasks from the at least one computing device.

11. The method of claim 10 further comprising receiving a log from the at least one computing device, wherein the log corresponds to a utilization report of respective one or more available computational resources to generate the result.

12. The method of claim 11 further comprising remunerating owner of the at least one computing device based on the log.

13. The method of claim 8, wherein the beacon message is received periodically.

14. The method of claim 8 further comprising maintaining a historical data of availability of the one or more computational resources for the at least one computing device.

15. The method of claim 14, wherein the one or more tasks are allocated based on the historical data.

16. The method of claim 8 further comprising assigning a reputation score to the one or more computational resources associated with the at least one computing device based, at in part on, the availability of the one or more computational resources and a quality of the one or more computational resources.

17. The method of claim 16, wherein the quality corresponds to at least one of a computing power of the one or more computational resources, or a measure of mean time to failure associated with the one or more computational resources.

18. The method of claim 16, wherein the one or more tasks are allocated to the at least one computing device based on the reputation score associated with one or more computational resources of the at least one computing device.

19. A computing device for processing one or more tasks, the computing device comprising:
one or more processors operable to:
communicate availability of one or more computational resources associated with the computing device to a marketplace server through a beacon message;
receive the one or more tasks from the marketplace server based on the availability of the one or more computational resources and a service level agreement associated with the one or more tasks;
execute the one or more tasks by utilizing the one or more available computational resources to generate a result; and
communicate the result to the marketplace server.

20. The computing device of 19, wherein the one or more processors is further operable to determine the one or more computational resources associated with the computing device.

21. The computing device of claim 19, wherein the availability of the one or more computational resources is periodically communicated to the marketplace server.

22. The computing device of claim 19, wherein the one or more processors is further operable to provide a user interface on the computing device that enables a user of the computing device to monitor the utilization of the one or more available computational resources.

23. The computing device of claim 19, wherein the one or more processors is further operable to maintain a log of utilization of the one or more available computational resources, and transmit the log to the marketplace server.

24. The computing device of claim 19, wherein the one or more processors is further operable to receive a payment from the marketplace server based on the utilization of the one or more available computational resources for executing the one or more tasks.

25. A marketplace server for allocating one or more tasks to at least one computing device, the marketplace server comprising:
one or more processors operable to:
receive a beacon message from the at least one computing device, wherein the beacon message comprises information on availability of one or more computational resources associated with the at least one computing device;
define a service level agreement for each of the one or more tasks based on the availability of the one or more computational resources; and
allocate the one or more tasks to the at least one computing device based on the service level agreement and the availability of the one or more computational resources.

26. The marketplace server of claim 25, wherein the one or more processors is further operable to receive the one or more tasks from one or more requestors.

27. The marketplace server of claim 25, wherein the one or more processors is further operable to receive a result for each of the one or more tasks from the at least one computing device.

28. The marketplace server of claim 27, wherein the one or more processors is further operable to receive a log from the at least one computing device, wherein the log corresponds to a utilization report of respective one or more available computational resources to generate the result.

29. The marketplace server of claim 28, wherein the one or more processors is further operable to remunerate user of the at least one computing device based on the log.

30. The marketplace server of claim 25, wherein the one or more processors is further operable to maintain a historical data of availability of the one or more computational resources for the at least one computing device.

31. The marketplace server of claim 30, wherein the one or more tasks are allocated based on the historical data.

32. The marketplace server of claim 25, wherein the one or more processors is further operable to assign a reputation score to the one or more computational resources associated with the at least one computing device based, at least in part on, the availability of the one or more computational resources and a quality of the one or more computational resources.

33. The marketplace server of claim 32, wherein the quality corresponds to at least one of a computing power of the one or more computational resources, or a measure of mean time to failure associated with the one or more computational resources.

34. The marketplace server of claim 33, wherein the one or more tasks are allocated to the at least one computing device based on the reputation score associated with one or more computational resources of the at least one computing device.

35. A computer program product for use with a computing device, the computer program product comprising a non-transitory computer-readable medium having a computer readable program code embodied therein for processing one or more tasks on the computing device, the computer readable program code executable by a processor in the computing device for:
communicating availability of one or more computational resources associated with the computing device to a marketplace server through a beacon message;
receiving the one or more tasks from the marketplace server based on the availability of the one or more computational resources and a service level agreement associated with the one or more tasks;
executing the one or more tasks by utilizing the one or more available computational resources to generate a result; and
receiving a payment from the marketplace server based on the utilization of the one or more available computational resources for executing the one or more tasks.
